(19) United States
(12) Patent Application Publication
(10) Pub. No.: US 2023/0092233 A1
(43) Pub. Date: Mar. 23, 2023

(54) TEAM ATMOSPHERE MEASUREMENT

(71) Applicant: International Business Machines Corporation, Armonk, NY (US)

(72) Inventors: Katsuroh Hayashi, Fujisawa-shi (JP); Kenichi Ishikawa, Nara (JP); Takashi Okano, Moriyama-shi (JP)

(21) Appl. No.: 17/480,207

(22) Filed: Sep. 21, 2021

(51) Int. Cl. G06Q 10/06

(52) U.S. Cl. CPC G06Q 10/063112

(57) ABSTRACT

An approach is provided in which the approach captures a set of individual indices corresponding to a set of psychological conditions of individual members of a team during a set of phases of a project. The approach computes, based on the set of individual indices, a set of team indices corresponding to the set of psychological conditions indicating a team state in each one of the set of phases of the project. The approach transmits a recommendation to a user in response to detecting a set of differences between the set of team indices and a set of expected values. The recommendation includes an action to increase the set of team indices.

### BACKGROUND

A business is only as good as its resources. Owners and managers who understand how to best utilize each resource help shape the success of a business. In addition, properly combining resources into teams to create heightened team chemistry further advances the business' objectives. Teams with heightened team chemistry understand each other's strengths and weaknesses and work in a manner that maximizes each other's' strengths and minimizes their weaknesses.

Many factors contribute to team chemistry and successful business owners and hiring managers understand their resources from a complete perspective. Talent and experience are not enough to be a good team member. The team member must also be willing and able to interact with other team members on the team, communicate and listen effectively, and put aside their own personal goals for team goals. To proceed with the project smoothly, a positive atmosphere needs to be maintained within a team throughout a project's life cycle.

A Tuckman model defines four different team development phases, which are a forming phase, a storming phase, a norming phase, and a performing phase. During the forming phase, the team meets and learns about the opportunities and challenges, and then agrees on goals and begins to tackle the tasks. The team members tend to behave quite independently during the forming phase. During the storming phase, the group starts to sort itself out and gain each other's' trust. This phase often starts when team members voice their opinions and conflicts may arise between team members as power and status are assigned.

During the norming phase, team members resolve disagreements and personality clashes, which results in greater intimacy and a spirit of co-operation emerges. This happens when the team is aware of competition and they share a common goal. And, during the performing phase, group norms and roles are established and group members focus on achieving common goals. This often leads to an unexpectedly high level of success. By this time, the team members are motivated, knowledgeable, competent, autonomous, and able to handle decision-making process without supervision.

### BRIEF SUMMARY

According to one embodiment of the present disclosure, an approach is provided in which the approach captures a set of individual indices corresponding to a set of psychological conditions of individual members of a team during a set of phases of a project. The approach computes, based on the set of individual indices, a set of team indices corresponding to the set of psychological conditions indicating a team state in each one of the set of phases of the project. The approach transmits a recommendation to a user in response to detecting a set of differences between the set of team indices and a set of expected values. The recommendation includes an action to increase the set of team indices.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is an exemplary diagram depicting a system that manages team atmosphere characteristics during team development phases and generates recommendations to increase the team atmosphere as needed;

FIG. 4 is an exemplary flowchart showing steps taken to increase team atmosphere characteristics throughout various team development phases;

FIG. 5 is an exemplary diagram depicting various team data conversion approaches;

FIG. 6 is an exemplary diagram depicting various determination approaches;

FIG. 7 is an exemplary diagram showing a determination logic improvement that adjusts expected values;

FIG. 8 is an exemplary diagram showing a determination logic improvement that adjusts criteria;

FIG. 9 is an exemplary diagram showing a determination logic improvement that adjusts a determination algorithm; and

FIG. 10 is an exemplary diagram depicting user input windows for a user to interface with system 300.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

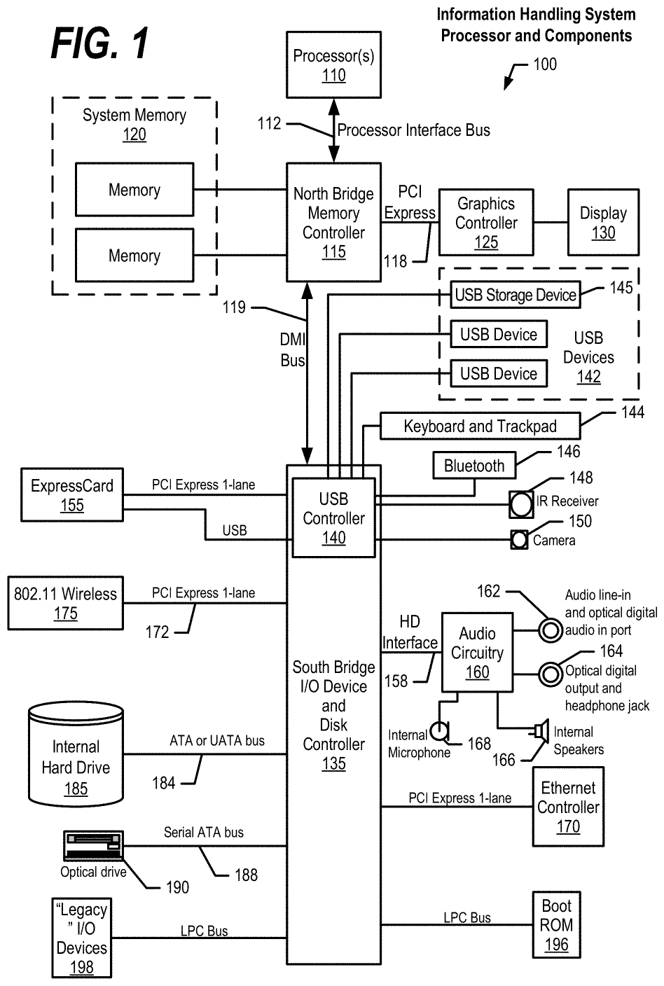

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, Peripheral Component Interconnect (PCI) Express bus 118 connects Northbridge 115 to graphics controller 125. Graphics controller 125 connects to display device 130, such as a computer monitor.

Northbridge 115 and Southbridge 135 connect to each other using bus 119. In some embodiments, the bus is a Direct Media Interface (DMI) bus that transfers data at high speeds in each direction between Northbridge 115 and Southbridge 135. In some embodiments, a PCI bus connects the Northbridge and the Southbridge. Southbridge 135, also known as the Input/Output (I/O) Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and Universal Serial Bus (USB) connectivity as it connects to Southbridge 135 using both the USB and the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, Integrated Services Digital Network (ISDN) connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the Institute of Electrical and Electronic Engineers (IEEE) 802.11 standards of over-the-air modulation techniques that all use the same protocol to wirelessly communicate between information handling system 100 and another computer system or device. Optical storage device 190 connects to Southbridge 135 using Serial Analog Telephone Adapter (ATA) (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality associated with audio hardware such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, Automated Teller Machine (ATM), a portable telephone device, a communication device or other devices that include a processor and memory.

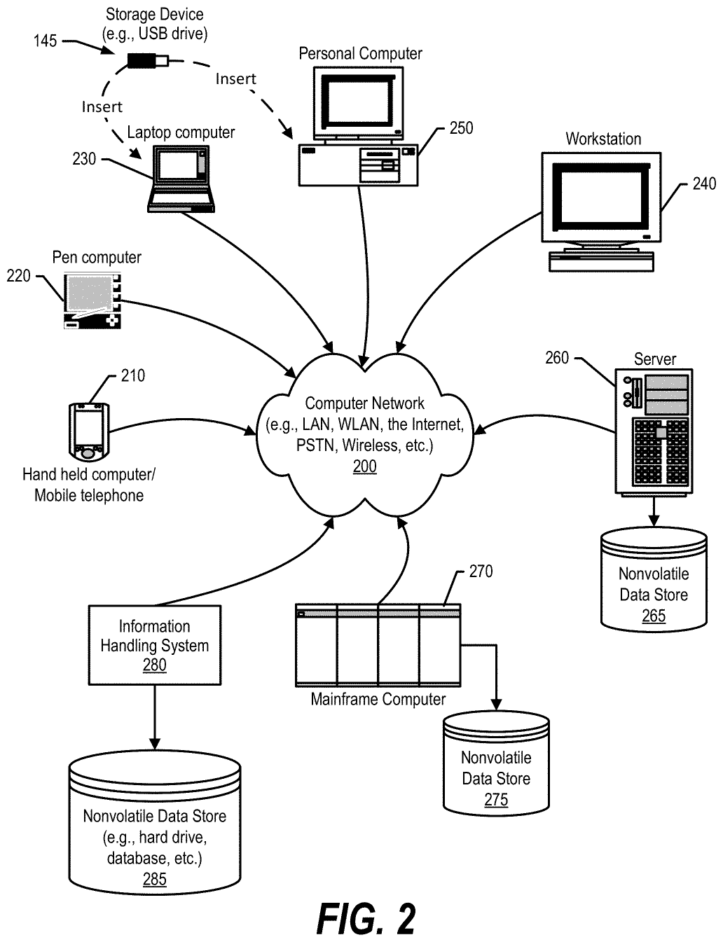

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as Moving Picture Experts Group Layer-3 Audio (MP3) players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. The embodiment of the information handling system shown in FIG. 2 includes separate nonvolatile data stores (more specifically, server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

As discussed above, team chemistry is essential for a successful project lifecycle. A challenge found today is that teams are typically formed by identifying team members based on their skills and availability. Many times, however, the team does not have natural chemistry, which leads to reduced motivation and inefficient team productivity. Today's systems evaluate individual team member characteristics but do not evaluate team atmosphere characteristics as a whole. In turn, a deficiency exists in observing team atmosphere multi-dimensionally, such as observing a combination of a team seriousness level, a team contribution level, and a team tension level.

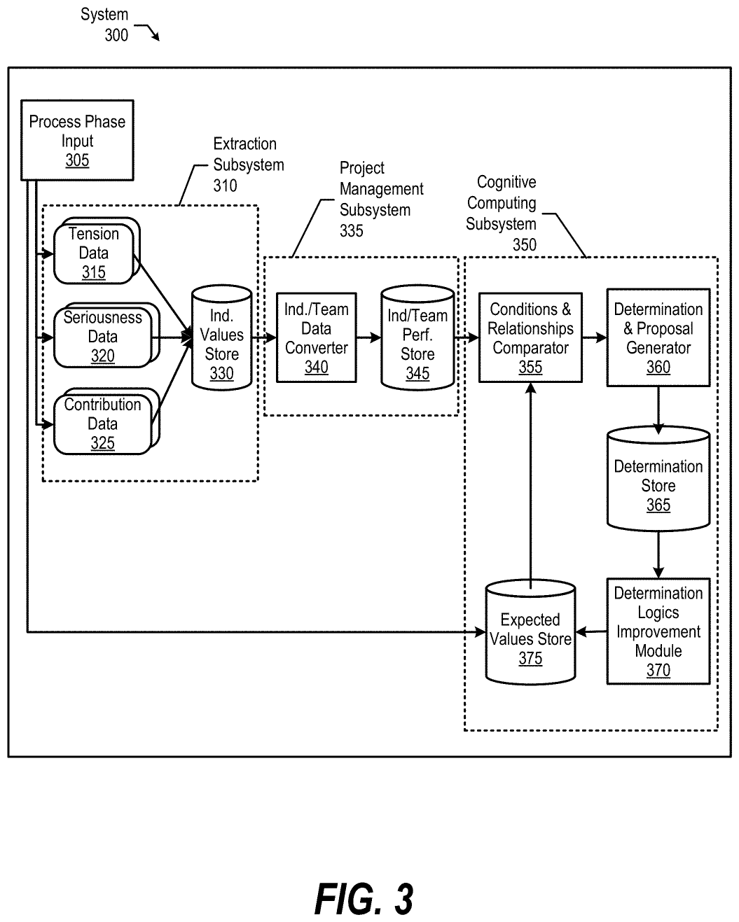

FIGS. 3 through 9 depict an approach that can be executed on an information handling system that enables multi-dimensional team atmosphere characteristics by measuring team tension levels, team seriousness levels, and team contribution levels. In one embodiment, the approach enables team atmosphere characteristic measurements during each team development phase by adding weightings to a key team member instead of processing all team members uniformly.

In another embodiment, when a difference exists between a measured team atmosphere and an expected team atmosphere in a certain phase, the approach generates a recommendation to improve the team atmosphere and enable a gradient result curve increase of the Tuckman model.

FIG. 3 is an exemplary diagram depicting a system that manages team atmosphere characteristics during team development phases and generates recommendations to increase the team atmosphere as needed.

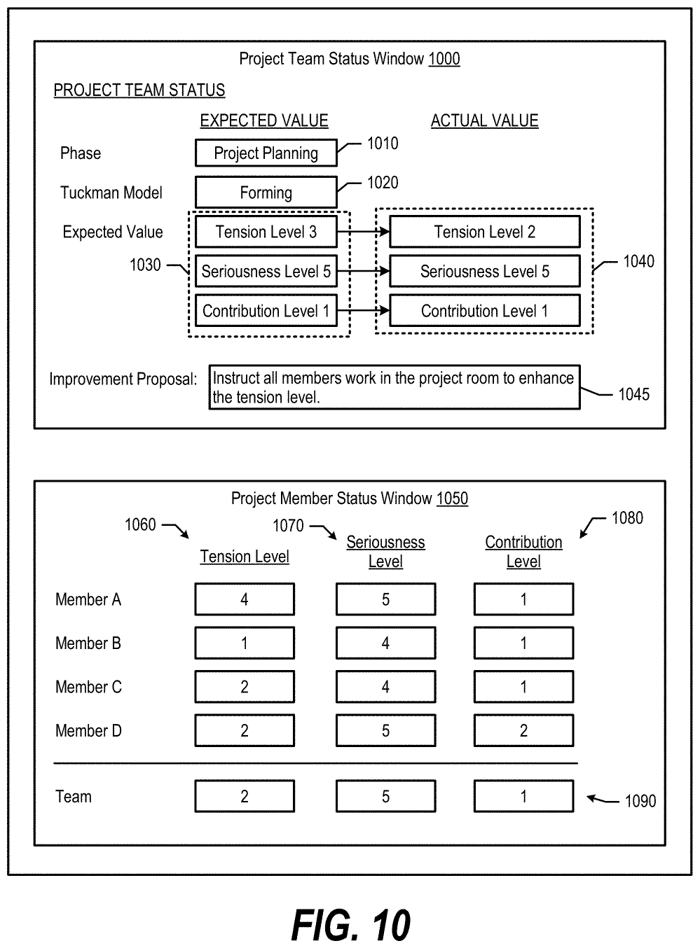

System 300 includes extraction subsystem 310, project management subsystem 335, and cognitive computing subsystem 350. In one embodiment, a project manager and team members input data via process phase input 305. Referring to FIG. 10, a project manager inputs a current team development phase (e.g., Tuckman development phase), and individual team members enter their individual team member characteristic values, also referred to herein as individual indices. In one embodiment, system 300 provides questions to the team members and generates the individual team member characteristic values based on the team members' answers.

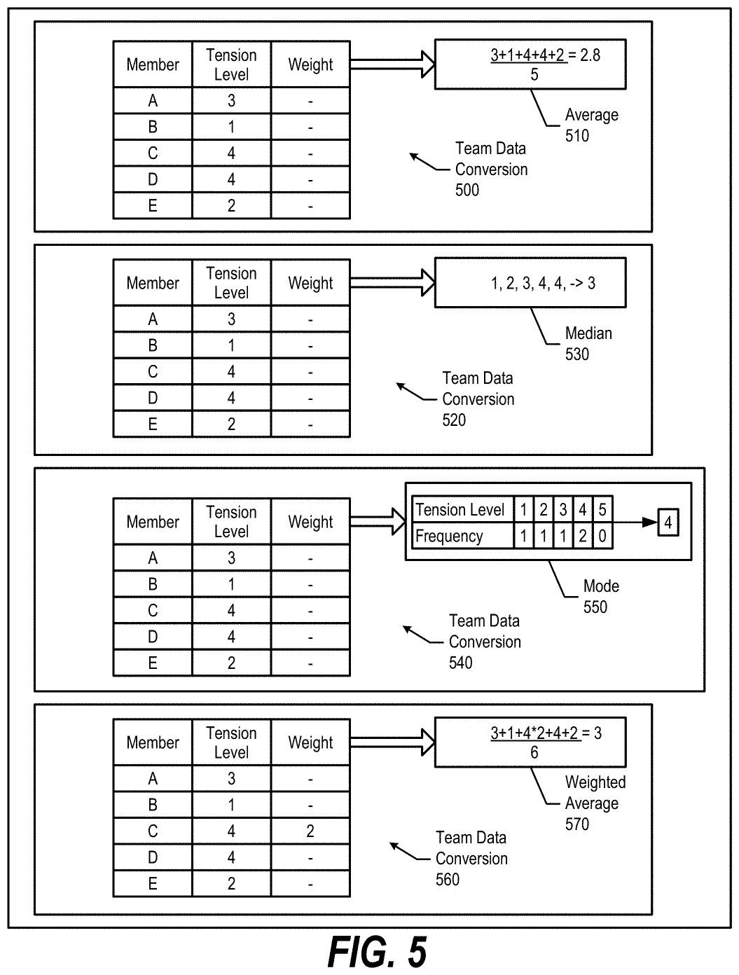

Extraction subsystem 340 obtains the individual team member characteristic values in the form of tension data 315, seriousness data 320, and contribution data 325. Tension data 315, seriousness data 320, and contribution data 325 include actual team member indices inputted by different team members (see FIGS. 5, 10, and corresponding text for further details). Extraction subsystem 310 stores the individual team member indices in individual values store 330.

Project management subsystem 335 uses individual/team data converter 340 to accumulate the individual team member indices from individual values store 330 and store them in individual/team performance store 345. In one embodiment, individual/team data convertor 340 uses team data conversions shown in FIG. 5.

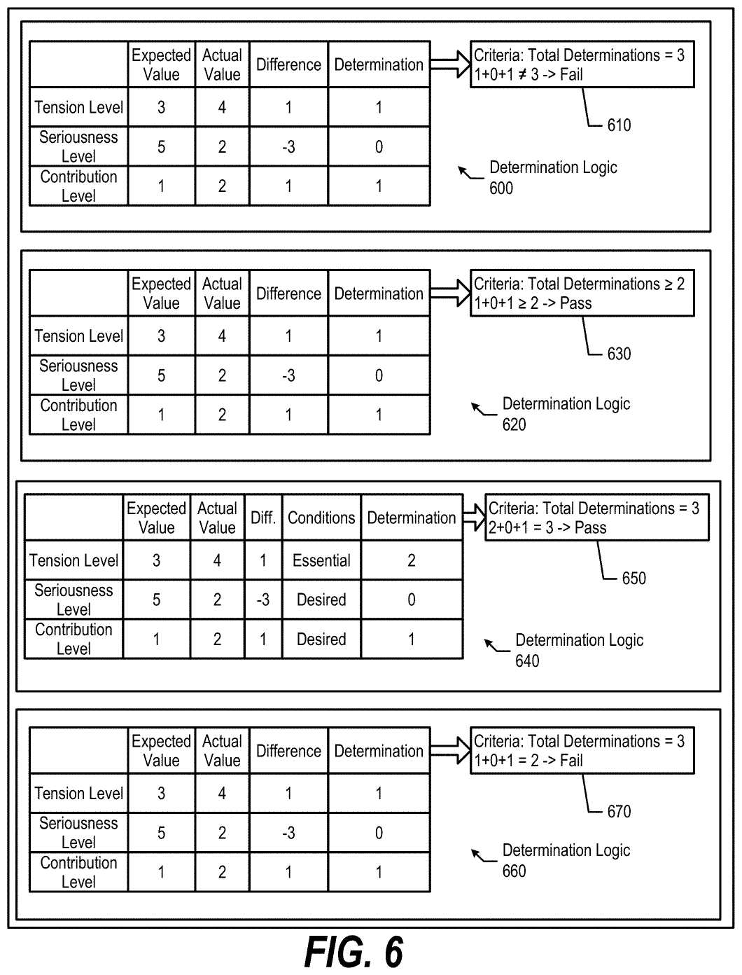

Cognitive computing subsystem 350 uses conditions and relationships comparator 355 to compare expected values from expected values store 375 of the selected team development phase with actual values from individual/team performance store 345 and compute differences (see FIG. 6 and corresponding text for further details).

Determination and proposal generator 360 uses a determination algorithm that evaluates the differences received from conditions and relationships comparator 355. Determination and proposal generator 360 uses various criteria to determine whether to generate a recommendation (see FIG. 6 and corresponding text for further details). In one embodiment, determination and proposal generator 360 triggers upon receipt of the team performance from the project management system by cognitive computing subsystem 350. In one embodiment, cognitive computing subsystem 350 extracts differences from the expected value and the performance computed by conditions and relationships comparator 355 and proposes recommendations to make a gradient result curve of the Tuckman model rise promptly according to determination logics:

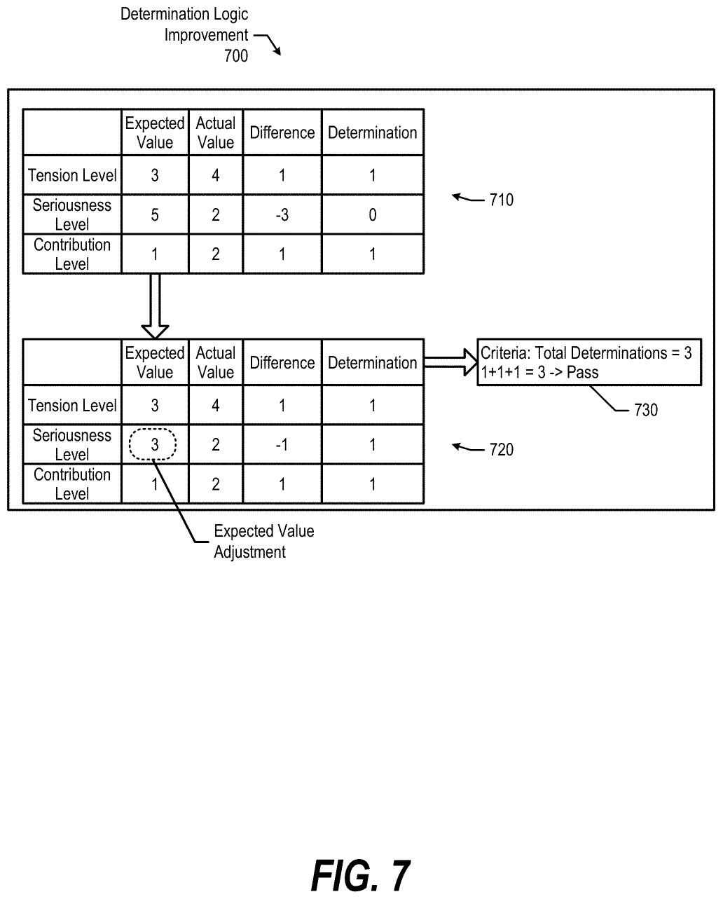

Determination logistics improvement module 370 identifies differences between expected values of ‘tension level,’ ‘seriousness level,’ and ‘contribution level’ and performances of individuals in a relevant phase (see FIG. 7 and corresponding text for further details). In one embodiment, determination logistics improvement module 370 identifies differences between expected values of ‘tension level,’ seriousness level,′ and ‘contribution level’ and performances among members in a relevant phase. In yet another embodiment, determination logistics improvement module 370 identifies differences between expected values of ‘tension level,’ seriousness level,′ and ‘contribution level’ and performances in a team in a relevant phase. In yet another embodiment, determination logistics improvement module 370 identifies differences between a relevant phase and a psychological phase obtained from self-reporting by each team member.

In one embodiment, the project manager notifies cognitive computing subsystem 350 of completion of the current process phase. At the completion of the process phase, determination logics improvement module 370 improves the determination logics by adjusting expected values reviews, adjusting criteria, and/or adjusting the determination algorithm (see FIGS. 7, 8, 9, and corresponding text for further details).

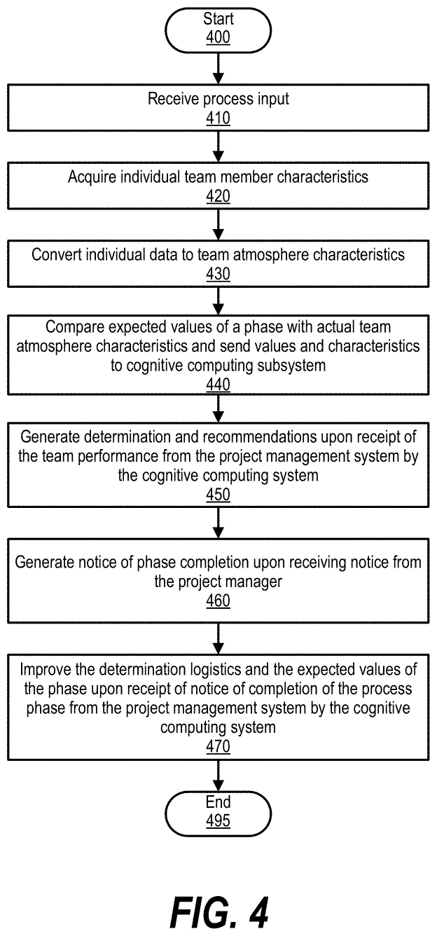

FIG. 4 is an exemplary flowchart showing steps taken to increase team atmosphere characteristics throughout various team development phases. FIG. 4 processing commences at 400 whereupon, at step 410, the process receives process input (e.g., process phase input 305) and, at step 420, the process acquires individual team member characteristics, such as tension data 315, seriousness data 320, and contribution data 325. As discussed above, the individual team member characteristics are also referred to as individual indices, or a set of individual indices.

At step 430, the process converts the individual team member characteristics into team atmosphere characteristics based on various conversion approaches (see FIG. 5 and corresponding text for further details). As discussed herein, the team atmosphere characteristics are also referred to herein as a set of team indices.

At step 440, the process compares expected values of a phase with actual team atmosphere characteristics and transfers the expected values with the actual values to cognitive computing subsystem 350.

At step 450, the process identifies differences between the expected values and the team atmosphere characteristics and generates recommendations based upon the current team development phase. In one embodiment, recommendations may include:
Instruct each team member to participate in brainstorming for active communications due to no sign of storming in the planning phase.
Reset shared roles in the execution or monitoring/controlling phase because psychological symptoms of the storming phase exist.
Assemble members in a project room from the start of the project to encourage prompt transition from the forming phase to the storming phase.
Detect a past similar project from accumulated data and present differences between expected values and performances, improvement proposals, and results in relation to the similar project.

At step 460, the process receives a phase completion notice from the project manager.

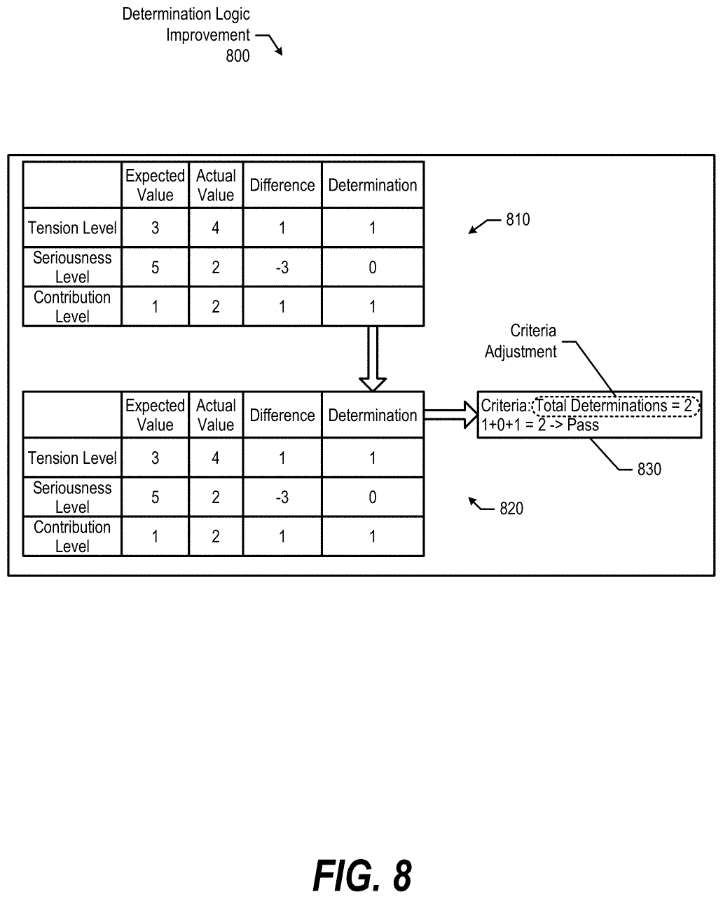

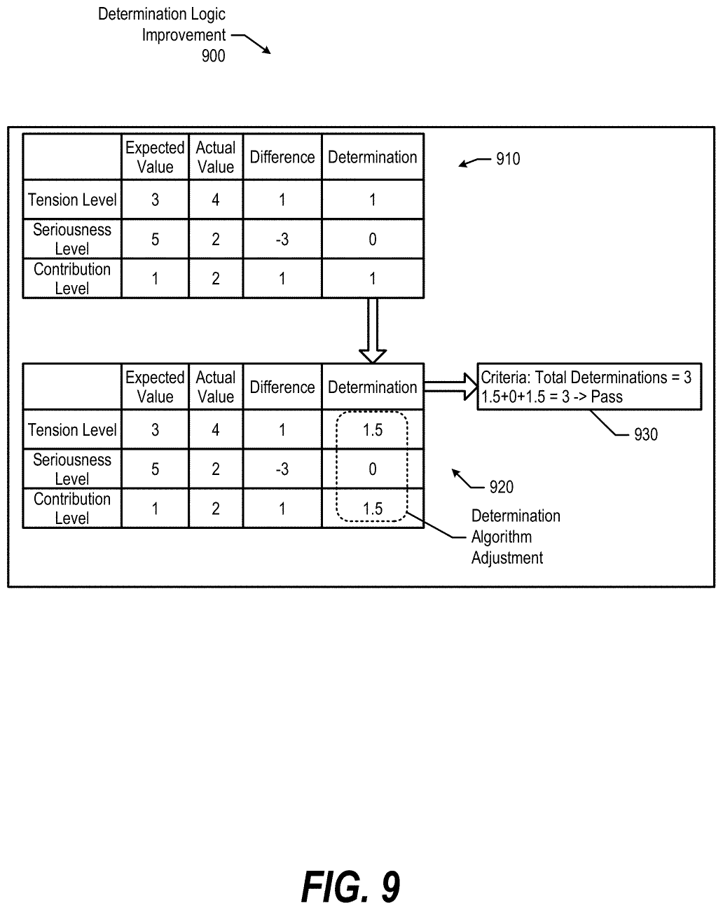

At step 470, the process improves the determination logistics and the expected values of the phase upon receipt of notice of completion of the process phase from the project management system. In one embodiment, the process improves the determination logic in one or more of three approaches. In the first approach, the determination logic adjusts how the expected values are reviewed, referred to herein as expected value adjustments (see FIG. 7 and corresponding text for further details). In the second approach, the determination logic adjusts the criteria, referred to herein as criteria adjustments (see FIG. 8 and corresponding text for further details). In the third approach, the determination logic adjusts the determination algorithm, referred to herein as determination algorithm adjustments (see FIG. 9 and corresponding text for further details). FIG. 4 processing thereafter ends at 495.

FIG. 5 is an exemplary diagram depicting various approaches to convert individual data to team data. Team data conversion 500 shows an averaging approach where system 300 averages the tension level reported by members A, B, C, D, and E. Window 510 shows that the average value is 2.8.

Team data conversion 520 shows an approach where system 300 computes a median value of the same tension level reported in example 500 by members A, B, C, D, and E. Window 530 shows that the median value is 3.

Team data conversion 540 shows an approach where system 300 computes a mode value of the same tension level reported in example 500 by members A, B, C, D, and E. Window 550 shows that the mode is 4.

Team data conversion 560 shows an approach where system 300 computes a weighted average of the tension levels reported in example 500 by members A, B, C, D, and E with an added weight column. Window 570 shows that the weighted average is 3. In one embodiment, system 300 applies increased weighting to team members at particular project phases that are important at the particular project phase to maximize team performance.

FIG. 6 is an exemplary diagram depicting various determination approaches. The four determination logic approaches shown in FIG. 6 evaluate expected values against actual team atmosphere values in relation to tension level, seriousness level, and contribution level, and determines if their difference meet a particular criteria. In one embodiment, system 300 via cognitive computing system 350 improves determination logic, expected values, and proposals at the completion of a process phase.

Determination logic 600 shows that the difference values are 1, −3, and 1 for the tension level, seriousness level, and contribution level, respectively. As such, the determination values are 1, 0, and 1. Decision 610 shows that the passing criteria is that the total number of determinations=3. As such, since determination logic 600 produces determinations of 1+0+1=2, the test fails, indicating that improvement is required.

Determination logic 620 generates the same differences and the same determinations as determination logic 600. However, decision 630 shows that the passing criteria is different from decision 610 and that the total number of determinations needs to be >2. Therefore, decision 630 passes.

Determination logic 640 generates the same differences and the same determinations as determination logic 600. However, determination logic 640 also includes a conditions column and weighed determination column. When a particular condition is deemed essential, table 640 shows that the determination value is weighted by 2. Decision 650 shows that the passing criteria is that the total number of determinations=3. Based on the weighted determinations, however, the total number of determinations is 2+0+1=3 and therefore the test passes. In one embodiment, cognitive computing subsystem 350 decides which conditions are essential based on the project information and past judgement results.

The determination algorithm is based on the following: Determination=1 if the divergence (downside) falls within 1; Determination=0 if the divergence (downside) is greater than 1. Determination logic 660 generates the same differences and the same determinations as determination logic 600. Decision 670 shows that the passing criteria is that the total number of determinations=3 and, based on the determination column from table 660, the total number of determinations is 1+0+1=2 and therefore the test fails. Decision 610 requires that all determination should be 1, whereas decision 670 requires that the actual value minus expected value should be more than −1.

FIG. 7 is an exemplary diagram showing a determination logic improvement that adjusts expected values. Determination logic improvement 700 shows table 710, which includes original expected values, actual values, differences, and determinations from determination logic 660 in FIG. 6. Table 720 shows an expected value adjustment to the seriousness level from 5 to 3. In one embodiment, system 300 decides to change the values at the completion of a process phase, and cognitive computing subsystem 350 decides which level to change and to what value based on past decision information.

Based on the expected value adjustment, the determination for the seriousness level changes from 0 to 1, and therefore decision 730 passes.

FIG. 8 is an exemplary diagram showing a determination logic improvement that adjusts criteria. Determination logic improvement 800 shows table 810, which includes original expected values, actual values, differences, and determinations from determination logic 660 in FIG. 6.

Table 820 shows the same expected values, actual values, differences, and determinations as table 810. However, decision 830 shows an adjustment in criteria from 3 required determinations to 2 required determinations. As such, based on the new criteria adjustment, decision 830 passes.

FIG. 9 is an exemplary diagram showing a determination logic improvement that adjusts a determination algorithm. Determination logic improvement 900 shows table 910, which includes original expected values, actual values, differences, and determinations from determination logic 660 in FIG. 6.

Table 920 shows different values in the determination column based on an adjustment by cognitive computing subsystem 350 to the determination algorithm of:

Determination=1.5 if no divergence(downside)

Determination=1 if the divergence(downside)falls within1

Determination=0 if the divergence(downside) is greater than1

As such, table 920 shows that the determination values of the tension levels and the contribution levels each increase to 1.5. Based on the new determination values, decision 930 passes.

FIG. 10 is an exemplary diagram depicting user input windows for a user to interface with system 300. Input screen 1000 allows a user to input a project phase into box 1010. When the user inputs a project phase into box 1010, system 300 automatically inserts a phase of the Tuckman model into box 1020 that corresponds with the project phase in box 1010.

In addition, system 300 adds expected values in boxes 1030 for the various levels. Input screen 1000 also includes actual values boxes 1040, which show the actual values of the team. In one embodiment, the actual values in boxes 1040 are highlighted when they fall below a corresponding expected value in boxes 1030, such as tension level 2 shown in FIG. 10. System 300 detects the item falling below the expected value and generates an improvement proposal in box 1045 to transmit to the team members.

Project member status window 1050 includes individual actual levels for the various team members in columns 1060, 1070, and 1080. Row 1090 is the overall team score for the various levels based on scoring the individual team member scores using team data conversions shown in FIG. 5.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A computer-implemented method comprising:
capturing, during a set of phases of a project, a set of individual indices corresponding to a set of psychological conditions of a plurality of individual members of a team;
computing, based on the set of individual indices, a set of team indices corresponding to the set of psychological conditions indicating a team state in each one of the set of phases of the project;
detecting a set of differences between the set of team indices and a set of expected values;
evaluating, by a determination generator in a cognitive computing system, the set of differences, wherein the determination generator utilizes a determination algorithm that applies a weighting based on a divergence between the set of team indices and the set of expected values;
in response to the evaluating, transmitting a recommendation to a user, wherein the recommendation comprises an action to increase the set of team indices; and
improving the determination generator by adjusting the determination algorithm in response to receiving a process phase completion notification from the user.

2. (canceled)

3. The computer-implemented method of claim 1 further comprising:
displaying a project team status window on a display to the user;
in response to receiving a phase status input from the user on the project team status window:
populating the project team status window with the set of expected values corresponding to the phase status input;
displaying the set of team indices on the project team status window; and
displaying the recommendation on the project team status window.

4. The computer-implemented method of claim 1 further comprising:
adjusting one or more of the set of expected values in response to receiving the process phase completion notification from the user.

5. The computer-implemented method of claim 1 further comprising:
adjusting one or more criteria in response to receiving the process phase completion notification from the user, wherein the one or more criteria is a basis of whether to transmit the recommendation to the user.

6. The computer-implemented method of claim 1 wherein the set psychological conditions comprise a tension level, a seriousness level, and a contribution level.

7. The computer-implemented method of claim 1 further comprising:
determining whether to transmit the recommendation during each one of the set of phases, wherein set of phases comprise a forming stage, a storming stage, a norming stage, and a performing stage.

8. An information handling system comprising:
one or more processors;
a memory coupled to at least one of the processors;
a set of computer program instructions stored in the memory and executed by at least one of the processors in order to perform actions of:
capturing, during a set of phases of a project, a set of individual indices corresponding to a set of psychological conditions of a plurality of individual members of a team;
computing, based on the set of individual indices, a set of team indices corresponding to the set of psychological conditions indicating a team state in each one of the set of phases of the project;
detecting a set of differences between the set of team indices and a set of expected values;
evaluating, by a determination generator in a cognitive computing system, the set of differences, wherein the determination generator utilizes a determination algorithm that applies a weighting based on a divergence between the set of team indices and the set of expected values;
in response to the evaluating, transmitting a recommendation to a user, wherein the recommendation comprises an action to increase the set of team indices; and
improving the determination generator by adjusting the determination algorithm in response to receiving a process phase completion notification from the user.

9. (canceled)

10. The information handling system of claim 8 wherein the processors perform additional actions comprising:
displaying a project team status window on a display to the user;
in response to receiving a phase status input from the user on the project team status window:
populating the project team status window with the set of expected values corresponding to the phase status input;
displaying the set of team indices on the project team status window; and
displaying the recommendation on the project team status window.

11. The information handling system of claim 8 wherein the processors perform additional actions comprising:
adjusting one or more of the set of expected values in response to receiving the process phase completion notification from the user.

12. The information handling system of claim 8 wherein the processors perform additional actions comprising:
adjusting one or more criteria in response to receiving the process phase completion notification from the user, wherein the one or more criteria is a basis of whether to transmit the recommendation to the user.

13. The information handling system of claim 8 wherein the set psychological conditions comprise a tension level, a seriousness level, and a contribution level.

14. The information handling system of claim 8 wherein the processors perform additional actions comprising:
determining whether to transmit the recommendation during each one of the set of phases, wherein set of phases comprise a forming stage, a storming stage, a norming stage, and a performing stage.

15. A computer program product stored in a computer readable storage medium, comprising computer program code that, when executed by an information handling system, causes the information handling system to perform actions comprising:
capturing, during a set of phases of a project, a set of individual indices corresponding to a set of psychological conditions of a plurality of individual members of a team;
computing, based on the set of individual indices, a set of team indices corresponding to the set of psychological conditions indicating a team state in each one of the set of phases of the project;
detecting a set of differences between the set of team indices and a set of expected values;
evaluating, by a determination generator in a cognitive computing system, the set of differences, wherein the determination generator utilizes a determination algorithm that applies a weighting based on a divergence between the set of team indices and the set of expected values;
in response to the evaluating, transmitting a recommendation to a user, wherein the recommendation comprises an action to increase the set of team indices; and
improving the determination generator by adjusting the determination algorithm in response to receiving a process phase completion notification from the user.

16. (canceled)

17. The computer program product of claim 15 wherein the information handling system performs further actions comprising:
displaying a project team status window on a display to the user;
in response to receiving a phase status input from the user on the project team status window:
populating the project team status window with the set of expected values corresponding to the phase status input;
displaying the set of team indices on the project team status window; and
displaying the recommendation on the project team status window.

18. The computer program product of claim 15 wherein the information handling system performs further actions comprising:
adjusting one or more of the set of expected values in response to receiving the process phase completion notification from the user.

19. The computer program product of claim 15 wherein the information handling system performs further actions comprising:
adjusting one or more criteria in response to receiving the process phase completion notification from the user, wherein the one or more criteria is a basis of whether to transmit the recommendation to the user.

20. The computer program product of claim 15 wherein the information handling system performs further actions comprising:
determining whether to transmit the recommendation during each one of the set of phases, wherein set of phases comprise a forming stage, a storming stage, a norming stage, and a performing stage.
